(19) United States
(12) Patent Application Publication
(10) Pub. No.: US 2011/0318592 A1
(43) Pub. Date: Dec. 29, 2011

(54) MOLDED ARTICLE AND METHOD FOR MAKING THE SAME

(75) Inventors: KUN-TSAN WU, Shindian (TW); LI-WEN TIEN, Shindian (TW)

(73) Assignee: FIH (HONG KONG) LIMITED, Kowloon (HK)

(21) Appl. No.: 12/861,906

(22) Filed: Aug. 24, 2010

(30) Foreign Application Priority Data
Jun. 28, 2010 (CN) 201010211063.3

(51) Int. Cl. B32B 15/04; B29C 45/14

(52) U.S. Cl. 428/464; 264/261; 264/257

(57) ABSTRACT

A molded article includes a first layer, a third layer, a second layer and a sealing layer, the first layer and the third layer are made of soft materials, the second layer and the sealing layer are made of plastic materials. The first layer and the third layer are combined to opposite sides of the second layer by the first injection molding step, the sealing layer encloses the edge of the molded article by the second injection molding step.

### CROSS-REFERENCE TO RELATED APPLICATIONS

This application is related to co-pending U.S. patent applications (Attorney Docket No. US33956 and US34279), both entitled “MOLDED ARTICLE AND METHOD FOR MAKING THE SAME”, by Kun-Tsan Wu. Such applications have the same assignee as the present application. The above-identified application is incorporated herein by reference.

### BACKGROUND

1. Technical Field

The present disclosure relates to a molded article and a method for making the same.

2. Description of Related Art

Molded articles, such as a molded housing of an electronic device, can be fabricated by injection molding. To improve the aesthetic appearance, inserting molding label (IML) is used to fabricate a decorative film to the plastic material to form the molded article, with the decorative layer forming on the outer surface of the molded article. However, due to shrinkage differences between the decorative film and the plastic materials, the edges of the molded article easily crack or break.

Therefore, there is room for improvement within the art.

### BRIEF DESCRIPTION OF THE DRAWINGS

Many aspects of the present molded article and method for making the same can be better understood with reference to the following drawings. The components in the various drawings are not necessarily drawn to scale, the emphasis instead being placed upon clearly illustrating the principles of the present molded article and method for making the same. Moreover, in the drawings, like reference numerals designate corresponding parts throughout the diagrams.

FIG. 1 is a sectional schematic view of a molded article according to an exemplary embodiment.

FIG. 2 is a sectional schematic view of a first mold during the molded article in initial molding process.

FIG. 3 is a sectional schematic view during the molded article in molding in a secondary molding process.

FIG. 4 is a sectional schematic view of the molded article according to another exemplary embodiment.

### DETAILED DESCRIPTION OF THE EMBODIMENT

The disclosed molded article can be a housing for an electronic device, such as a mobile phone, a personal digital assistant (PDA), etc.

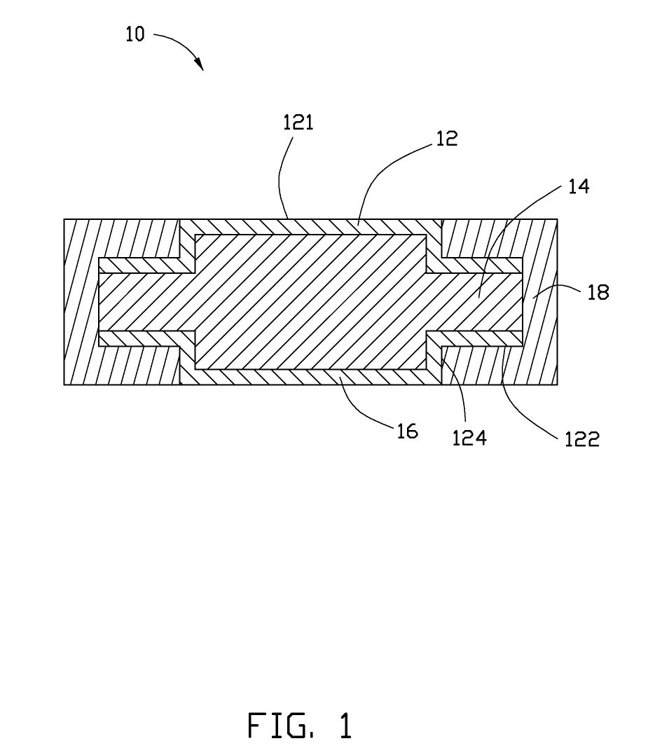

FIG. 1 shows a molded article 10 according to a first exemplary embodiment including a first layer 12, a second layer 14 and a third layer 16. The molded article 10 can be made by injection molding, that is, combining the first layer 12 and the third layer 16 to the opposite sides of the second layer 14, respectively.

The first layer 12 and the third layer 16 both are soft layers, and can be selected from a group including leather, textile, and film, which have a capability of good wear-resistant and softness. The first layer 12 and the third layer 16 can form patterns in the inner surfaces thereof. The inner surfaces combine with the second layer 14, so the patterns can be protected effectively. The second layer 14 may be made of a plastic material selected from a group including polycarbonate, polymethyl methacrylate, polystyrene, or any desired combination thereof. The first layer 12 and the third layer 16 combine with the opposite sides of the second layer 14.

Understandably, the first layer 12 and the third layer 16 can be embedded onto the second layer 14, or one of the first layer 12 of the third layer 16 is embedded onto the second layer 14, and if needed, reinforcing the bond with adhesive (not shown) placed between the layers. The adhesive can be made of polyurethane, epoxy resin, or a combination of the two.

The molded article 10 includes a main portion 121 and an edge portion 122 extending at the periphery of the main portion 121. The edge portion 122 laterally extends from the middle portion of the side wall of the main portion 121, and is shorter than the main portion 121, thereby forming two opposite step walls 124 on the side wall of the main portion 121.

To prevent the edge portion 122 of the molded article 10 from separating at the edge, the molded article 10 further includes an additional sealing layer 18. The sealing layer 18 can be made of plastic materials, the sealing layer 18 encloses the edge portion 122 and fills in the area that is enclosed by the edge portion 122 and the step wall 124. The end surfaces of the sealing layer 18 abut against the step walls 124 to cover the end surfaces. The sealing layer 18 can be formed by a second injection molding step.

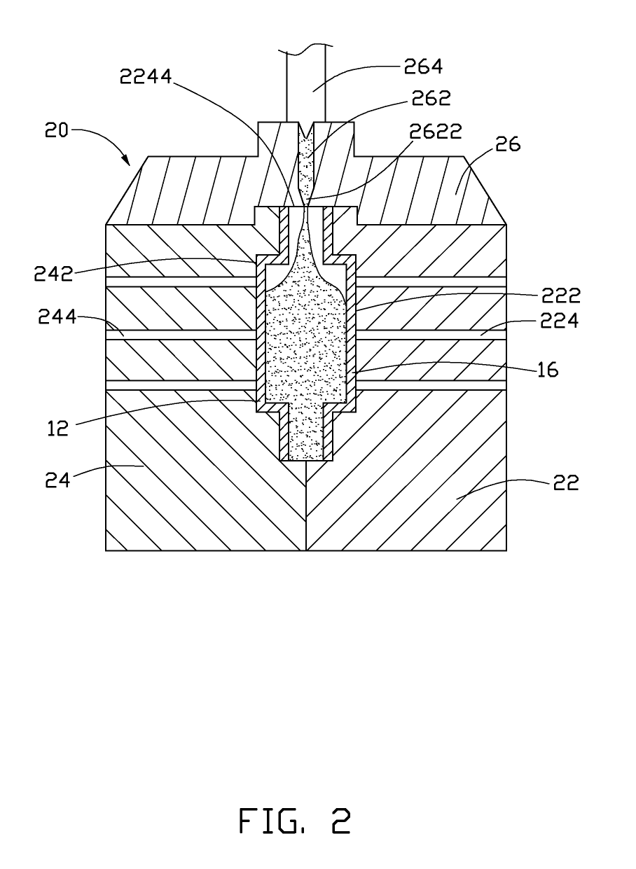

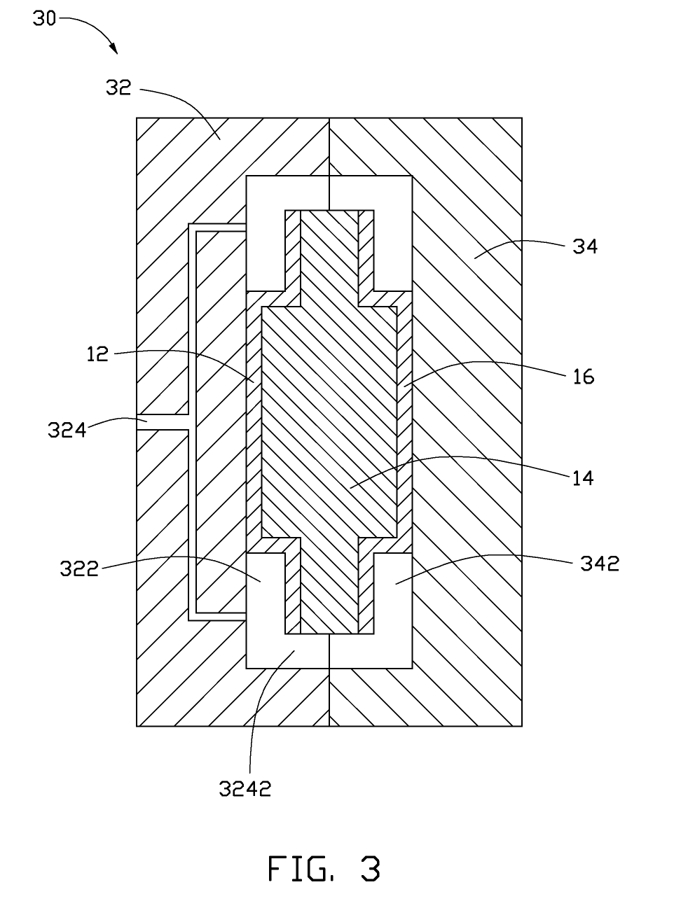

Referring to FIGS. 2 and 3, to fabricate the molded article 10, a first layer 12 has first patterns printed on one surface thereof, and a third layer 16 having second patterns printed on one surface thereof. A first mold 20 includes a female mold 22, a male mold 24 engaging with the female mold 22, and a feeding plate 26 engaging with the female mold 22 and the male mold 24. The female mold 22 defines a cavity 222 and first suction holes 224. The first suction holes 224 run through the female mold 22 and communicate with the cavity 222. The male mold 24 forms a core 242 and defines second suction holes 244, the second suction holes 244 run through the male mold 24 and the core 242. The female mold 22 engages with the male mold 24, and the core 22 extends into the cavity 222 to form a chamber 2244. The feeding plate 26 is arranged to engage with the female mold 22 and the male mold 24. The feeding plate 26 defines a channel 262 for passing of molding plastics. The channel 262 has a nozzle 2622 to communicate with the chamber 2244.

The first layer 12 is secured onto the core 242 by a vacuum communicating with the second suction holes 244, with the first patterns facing the cavity 222 of the female mold 22. The third layer 16 is secured into the cavity 222 by a vacuum communicating with the first suction holes 224, with the second patterns facing the core 242 of the male mold 24. The female mold 22 engages with the male mold 24, and the core 242 extends into the cavity 222 to form the chamber 2244. The feeding plate 26 engages with the female plate 22 and the male plate 24, enabling the nozzle 2622 of the channel 262 to communicate with the chamber 2244. A first plastic molding material is injected into the chamber 2244 through the channel 262 and forms the second layer 14. The second layer 14 integrally combines with the first layer 12 and the third layer 16 to form a preform article (not labeled). The preform article is taken out of the first mold 20 after the first mold 20 cooled. The preform article has the main portion 121, the edge portion 122, and the opposite step walls 124 on the side walls of the main portion 121 (shown in FIG. 1).

A second mold 30 includes a female mold 32 and a male mold 34 engaging with the female mold 32. The female mold 32 defines a cavity 322 and a second channel 324. The second channel 324 runs through the female mold 32 and communicates with the cavity 322. The male mold 34 forms a core 342 to engage with the cavity 322. The female mold 32 engages with the male mold 34, the core 342 extends into the cavity 322 to form a second chamber 3242 having shape and size as the molded article 10.

The preform article is placed into the cavity 322, then, the female mold 32 engages with the male mold 34, and the core 342 extends into the cavity 322 to form the chamber 3242. A second plastic molding material is injected into the second chamber 3242 through the second channel 324 and integrally combine the preform article to form the molded article 10. The second plastic molding material forms the sealing layer 18. The sealing layer 18 encloses the edge portion 122 and fills in the area that is enclosed by the edge portion 122 and the step wall 124. In this case, the end surfaces of the sealing layer 18 abut against the step walls 124. The molded article 10 can then be removed.

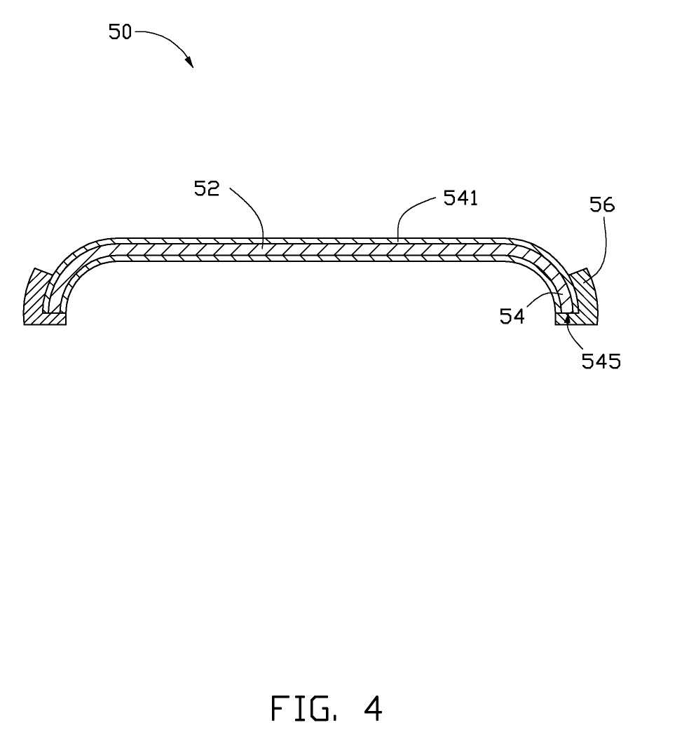

It is to be understood that the molded article can have other structures. For example, FIG. 4 shows another molded article 50 including a main portion 52 and an edge portion 54 having the same thickness as the main portion 52. Accordingly, the edge portion 54 can evenly connect to the main portion 52. A sealing layer 56 has an L-shaped cross-section and covers the end surface 545 of the edge portion 54. A portion of the sealing layer 56 extends to a first layer 541 of the molded article 50 and partly covers the periphery of the first layer 541, that is, the side surface of the edge portion 54.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A molded article, comprising:
a first layer and a third layer both made of soft materials;
a second layer and a sealing layer both made of plastic materials; wherein:
the first layer and the third layer are combined to opposite sides of the second layer, and the sealing layer encloses at least one edge of the molded article to prevent the first layer and the third layer from separating from the second layer.

2. The molded article as claimed in claim 1, wherein either of the first layer and the third layer can be made of a soft material selected from a group including leather, textile, and film.

3. The molded article as claimed in claim 1, wherein the molded article includes a main portion and an edge portion, the edge portion laterally extends form the middle portion of the side wall of the main portion and is shorter than the main portion, thereby forming opposite step walls on the side wall of the main portion.

4. The molded article as claimed in claim 3, wherein the sealing layer encloses the edge portion and fills in the area that is enclosed by the edge portion and the step wall, with the end surfaces of the sealing layer abutting against the step walls to cover the end surfaces.

5. The molded article as claimed in claim 1, wherein the molded article includes a main portion and an edge portion, the edge portion evenly connects to the main portion, the sealing layer has a L-shaped cross-section and covers the end surface of the edge portion, the sealing layer extends to partly cover the side surface of the edge portion.

6. A method for making a molded article, comprising:
providing a first mold, the first mold including a male mold and a female mold engaging with the male mold, one of the male mold and the female mold defining a cavity, and the other forming a core engaging with the cavity to form a first chamber;
placing a first layer on the core and a third layer into the cavity;
engaging the female mold with the male mold, injecting a first plastic material into the first chamber, the first plastic material combining the first layer and the third layer to form a preform article, the first plastic material forming a second layer between the first layer and the third layer;
providing a second mold having a second chamber, placing the preform article into the second chamber, injecting a second plastic material into the second chamber, the second plastic material integrally combining with the preform article to form the molded article, the second plastic molding material forming a sealing layer enclosing the edge of the molded article.

7. The method for making the molded article as claimed in claim 6, wherein the first mold includes a feeding plate engaging with the female mold and the male mold, the feeding plate defines a channel for passing of the first plastic material, the channel has a nozzle to communicate with the first chamber.

8. The method for making the molded article as claimed in claim 6, wherein either of the first layer and the third layer can be a soft layer selected from a group including leather, textile, and film.

9. The method for making the molded article as claimed in claim 6, wherein the molded article includes a main portion and an edge portion, the edge portion laterally extends from the middle portion of the side wall of the main portion and is shorter than the main portion, thereby forming opposite step walls on the side wall of the main portion.

10. The method for making the molded article as claimed in claim 9, wherein the sealing layer encloses the edge portion and fills in the area that enclosed by the edge portion and the step wall, with the end surfaces of the sealing layer abutting against the step walls to cover the end surfaces.

11. The method for making the molded article as claimed in claim 6, wherein the molded article includes a main portion and an edge portion, the edge portion evenly connects to the main portion, the sealing layer has an L-shaped cross-section and covers the end surface of the edge portion, the sealing layer extends to partly cover the side surface of the edge portion.
